(19) United States
(12) Patent Application Publication
(10) Pub. No.: US 2005/0039973 A1
(43) Pub. Date: Feb. 24, 2005

(54) Yaw, pitch and roll apparatus for a multiple unit vehicle

(76) Inventor: Bruce Clark, Tieton, WA (US)

Correspondence Address: Floyd E. Ivey;Liebler, Ivey, Connor & Berry, P.O. Box 6125, Kennewick, WA, 99336, US

(21) Appl. No.: 10/647,030

(22) Filed: Aug. 21, 2003

(51) Int. Cl. B62D 5/06

(52) U.S. Cl. 180/418

(57) ABSTRACT

An apparatus permitting pitch, yaw and roll interrelationship between multiple vehicle units.

### FIELD OF THE INVENTION

This invention relates to articulated vehicles and more particularly to an apparatus permitting pitch, yaw and roll interrelationship between multiple vehicle units.

### BACKGROUND OF THE INVENTION

Articulated vehicles with apparatus permitting yaw, pitch and roll interconnections are known in the arts including U.S. Pat. No. 4,545,454 to Bas; U.S. Pat. No. 5,366,299 to Hughes; U.S. Pat. No. 4,482,165 to Dawson et al; and U.S. Pat. No. 5,456,185 to Rother et al. The patents referred to herein are provided herewith in an Information Disclosure Statement in accordance with 37 CFR 1.97.

### SUMMARY OF THE INVENTION

The present invention is an apparatus creating yaw, pitch and roll interconnections between vehicles in a multiple unit vehicle. Pitch is provided by a hinge connection with one hinge first leaf affixed, generally by an immovable affixing means including welding, bolting, riveting and other such immovable means to a first vehicle unit. The first leaf is connected to a second leaf by hinge means provided in the preferred embodiment as a shaft received by outwardly extending planar elements, presenting apertures, extending from each of the first leaf and the second leaf thereby permitting shaft interconnection of the first leaf and the second leaf allowing the first leaf and the second leaf to revolve relative to the other. The orientation of the first and second hinged leaves, comprising the pitch assembly, is such as to respond with pitch movement, between the first and the second vehicle when the vehicle is subject to a pitch position as it transits terrain.

A roll assembly comprised or roll means and provided, in the preferred embodiment, of a threaded unit received by a complementary threaded unit. Those of ordinary skill in the mechanical arts will recognize that other threaded configurations will provide an equivalent function. The complementary threaded unit, either male or female, depending on the form of the threaded unit, is affixed by means to a second vehicle. Such affixing means includes but is not limited to welding, bolting, riveting and other such immovable affixing means. The threaded unit is affixed to a threaded unit plate again by such similar affixing means. The roll assembly is interconnected to the second vehicle unit in an orientation to allow roll movement between the first vehicle unit and the second vehicle unit when the multi-unit vehicle traverses terrain imposing roll forces of the first vehicle unit relative to the second vehicle unit. The threaded unit plate of the roll assembly and the second leaf of the pitch assembly are interconnected by the yaw assembly.

The yaw assembly is comprised of at least one plate extending from the second leaf to present an aperture for alignment with at least one plate extending from the threaded unit plate which presents an aperture for alignment with said apertures receiving shaft joining means. The orientation of the yaw assembly plates is such as to allow yaw movement between the first vehicle unit and the second vehicle unit when the first vehicle unit yaw turns relative to the second vehicle unit. The aligned apertures receive either rotatable shaft means and or yaw motor means. A yaw motor, comprised in the preferred embodiment of an electric, pneumatic or hydraulic motor, is immovably affixed to either the plate extending from the second leaf or the plate extending from the threaded unit plate with a shaft and key-notch interconnecting with the opposing plate so as to exert yaw forces on the respective second leaf and threaded unit plate thereby creating a turning force vis-a-vis the first and the second units. A vehicle steering means will provide electric, pneumatic and or hydraulic signals or forces at the yaw motor means causing the exertion of yaw power.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

FIG. 1 is a plan view of a multi-unit vehicle interconnected with a yaw, pitch and roll apparatus.

FIG. 2 is a side elevation of a multi-unit vehicle showing the yaw, pitch and roll apparatus.

FIG. 3 illustrates the apparatus in pitch orientation.

FIG. 4 illustrates the apparatus showing the pitch assembly, the yaw assembly and the roll assembly.

FIG. 5 illustrates the apparatus in an exploded view where the yaw assembly comprises one first yaw assembly plate motor and shaft means interconnected, for yaw power, to at least one second yaw assembly plate. Also seen are the components of the pitch assembly and the roll assembly.

FIG. 6 is an exploded view of the pitch, yaw and roll assembly showing the yaw assembly with at least one first yaw assembly plate and at least one first top assembly plate for presentation of apertures for alignment and interconnection with at least one second yaw assembly plate and at least one top second yaw assembly plate to receive shaft and or yaw motor with shaft and or shaft and gear interconnection.

### DETAILED DESCRIPTION

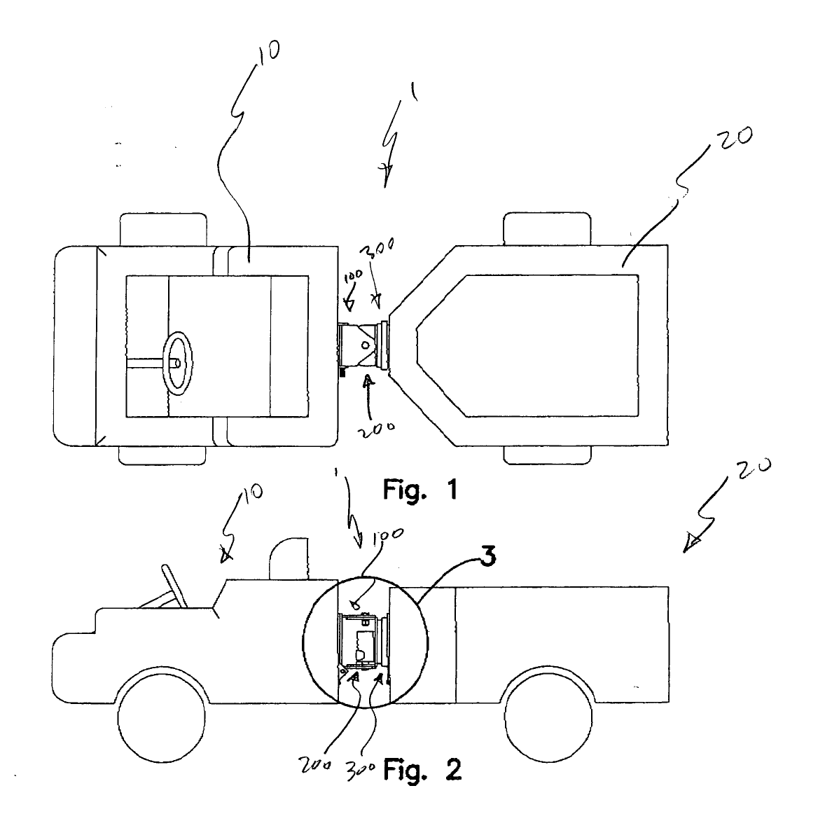

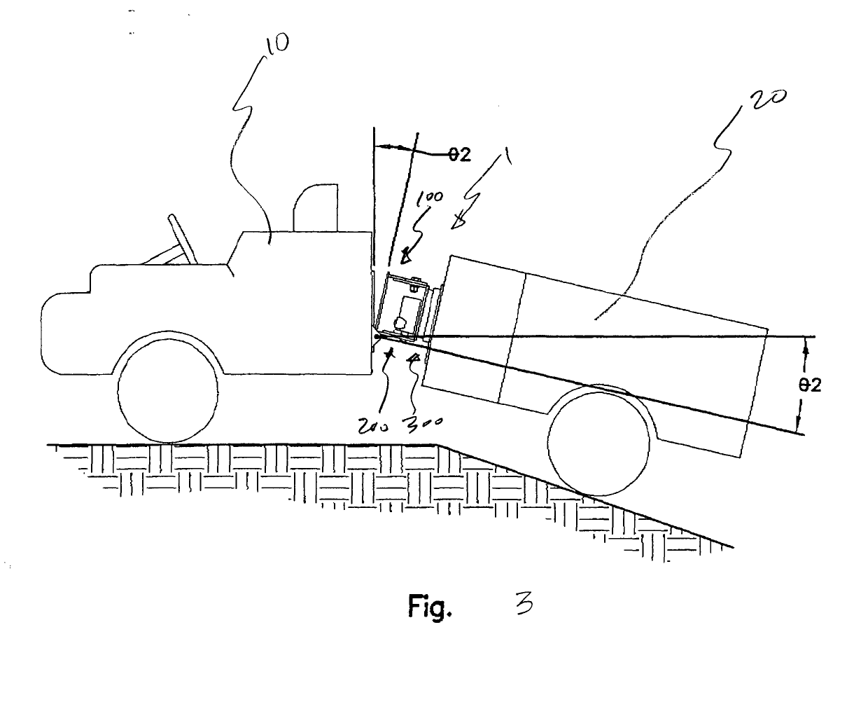

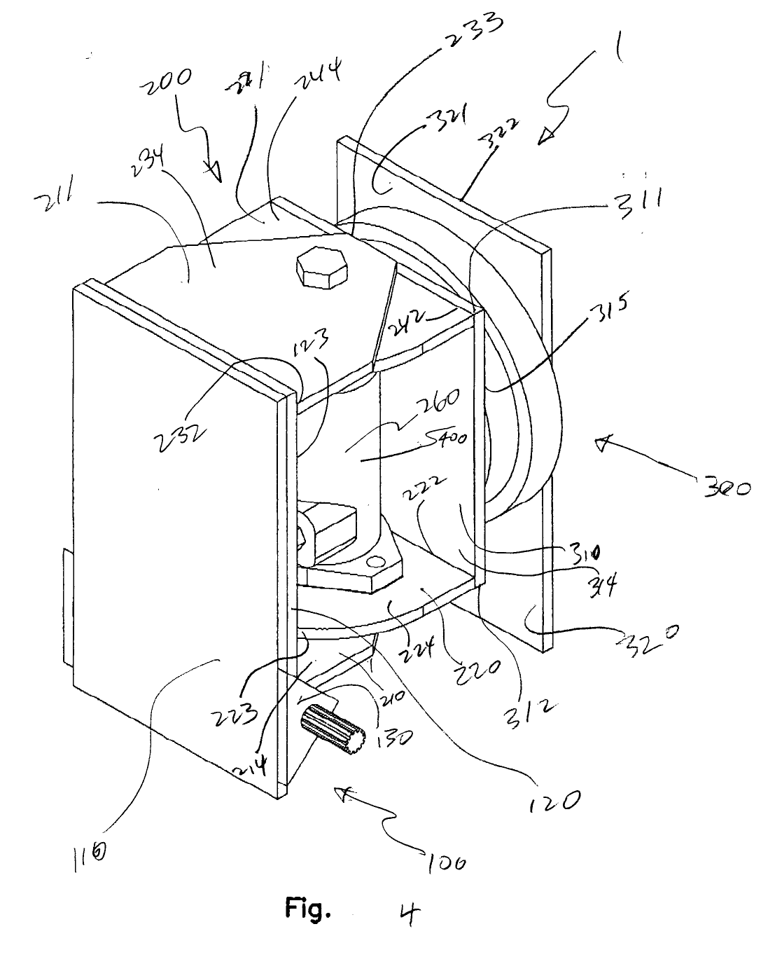

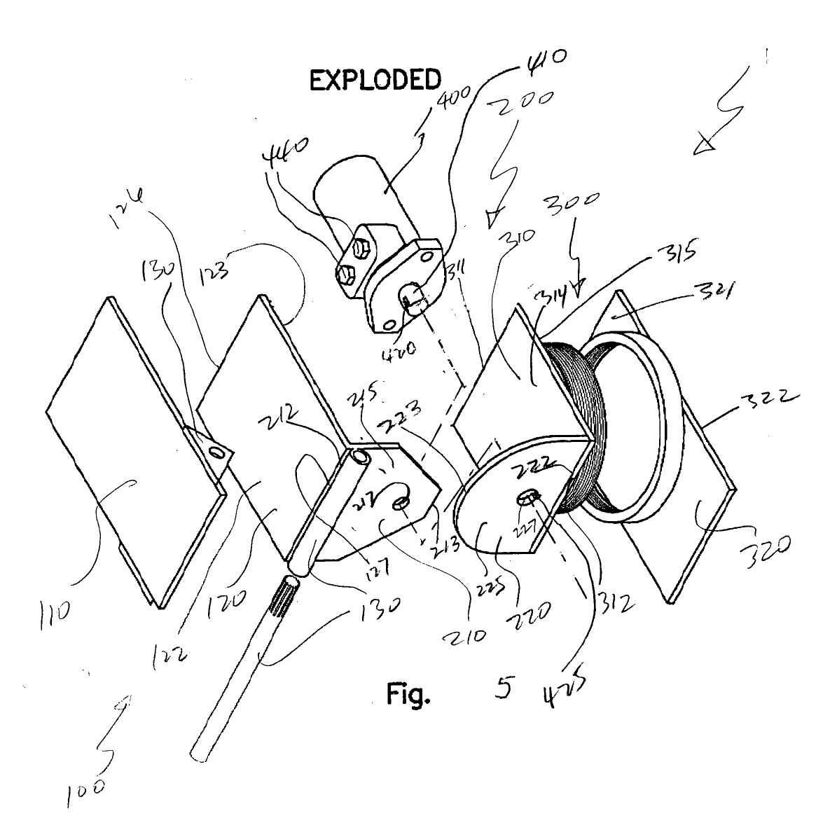

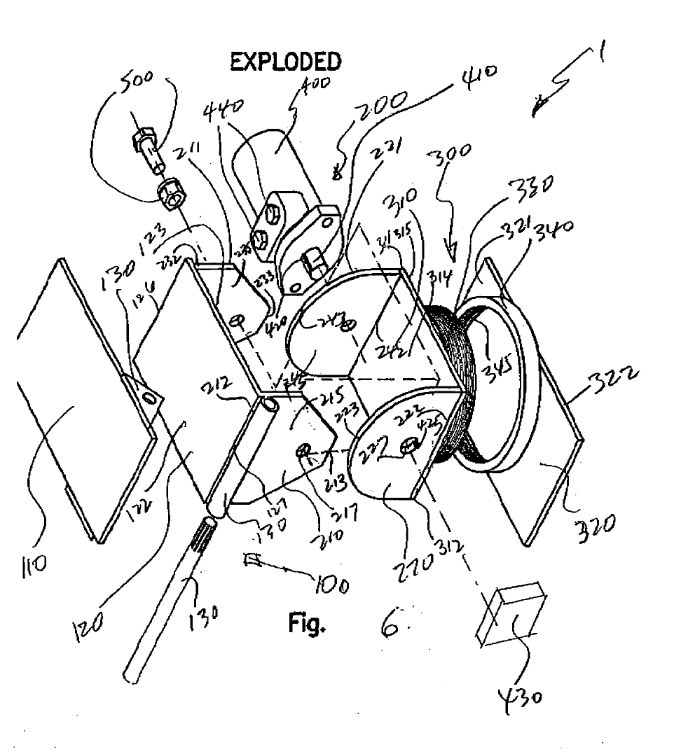

FIGS. 1 through 6 show a multi-unit vehicle and the interconnection apparatus of a yaw, pitch and roll apparatus to and between multiple vehicle units. FIGS. 1 and 2 demonstrate plan and elevation views showing the interrelation of the yaw, pitch and roll apparatus of this invention. FIG. 3 illustrates the pitch interrelationship provided when the multi-unit vehicle traverses pitch force imposing movement. FIG. 4 illustrates the apparatus assembled while FIGS. 5 and 6 illustrate exploded views.

As seen in FIGS. 4, 5 and 6, a yaw, pitch and roll articulated assembly (1) for a multi-unit vehicle is comprised of a pitch assembly (100) interrelated with a yaw assembly (200) and a roll assembly (300).

Pitch Assembly

The pitch assembly (200) has pitch means (130); said pitch assembly (100) having pitch assembly interconnection means to a first vehicle unit (10); pitch means (130) allowing a pitch relationship between the first vehicle unit (10) and a second vehicle unit (20). Pitch assembly interconnection means to a first vehicle unit comprised of affixing means including welding, nut and bolt, rivet and other equivalent means. The pitch assembly interconnection means to a first vehicle unit (10) is comprised of a first hinge leaf or first pitch interconnection plate (110) affixed by interconnection affixing means to the first vehicle unit (10). The first pitch interconnection plate (110) is pitch rotatably affixed by pitch interconnection affixing means (130) to a pitch assembly attachment plate (120) or a second hinge leaf. The first pitch interconnection plate (110) is affixed to the first vehicle unit (10) in an orientation to permit pitch movement between the first vehicle unit (10) and the second vehicle unit (20). The pitch assembly attachment plate (120) is immovably connected, by affixing means, to at least one first yaw assembly plate(210) thereby providing interconnection between the pitch assembly (100) and the yaw assembly (200). Immovable affixing means includes welding, bolting, riveting and other equivalent affixing means. The pitch-yaw assembly interconnection means of the pitch assembly (100) and the yaw assembly (200) rotatably interconnects the pitch assembly (100) with the yaw assembly (200). The pitch assembly attachment plate (120) has an assembly plate first side (122), an assembly plate second side (123), an assembly plate top (126) and an assembly plate bottom (127).

The first pitch interconnection plate (110) is affixed by rotatable pitch interconnection affixing means (130) to the pitch assembly attachment plate (120) at the assembly plate front side (124) proximal the assembly plate bottom (127) or at the assembly plate bottom (127). The first pitch interconnection plate (110) is affixed by rotatable pitch interconnection affixing means (130) to the assembly plate first side (122) intermediate the assembly plate top (126) and the assembly plate bottom (127) or proximal the assembly plate bottom (127). The rotatable pitch interconnection affixing means (130), in the preferred embodiment, is comprised of hinge means (130).

Yaw Assembly

The yaw assembly (200) has yaw means and the said yaw assembly (200) has pitch-yaw assembly interconnection means of the pitch assembly (100) and the yaw assembly (200). The yaw assembly (200) has yaw-roll assembly interconnection means and yaw means which allows a yaw relationship between the first vehicle unit (10) and the second vehicle unit (20). The at least one first yaw assembly plate (210) has a first yaw assembly plate edge (212), an extension edge (213), a first yaw assembly plate top (214) and a first yaw assembly plate bottom (215). The at least one first yaw assembly plate edge (212) is immovably affixed by edge affixing means at the assembly plate second side (123). Immovable affixing means includes welding, bolt and nut, rivet and other such affixing means. The extension edge (213) is distal from the first yaw assembly plate edge (212)and the at least first yaw assembly plate (210) extends from the assembly plate second side (123) outwardly from the assembly plate second side (123). The at least one second yaw assembly plate (220) has a second yaw assembly plate edge (222), a second extension edge (223), a second yaw assembly plate top (224) and a second yaw assembly plate bottom (225). The at least one second yaw assembly plate edge is immovably affixed by edge affixing means at the yaw-roll interface plate (310) at a yaw surface (314). The second extension edge (223) is distal from the at least second yaw assembly plate edge (222). The at least second yaw assembly plate (220) extends from the yaw surface (314) outwardly from the yaw surface (314). The yaw-roll interface plate (310) has a yaw-roll interface plate top (311) and a yaw-roll interface plate bottom (312). Yaw interconnection means interconnects the at least one first yaw assembly plate (210) and the at least one second yaw assembly plate (220) proximal the respective extension edge (213) and second extension edge (223). Yaw interconnection means receives yaw power means to urge the at least one first yaw assembly plate (210) to yaw rotate with respect to the at least one second assembly plate (220).

In the preferred embodiment, the first yaw assembly plate edge (212) is immovably affixed by edge affixing means at the assembly plate second side (123) intermediate the assembly plate top (126) and the assembly plate bottom (127) or proximal the assembly plate bottom (127). Yaw interconnection means which interconnects the at least one first yaw assembly plate (210) and the at least one second yaw assembly plate (220) is proximal the respective extension edge (213) and second extension edge (223) and is comprised of at least one first aperture (217), from the first yaw assembly plate top (214) to the first yaw assembly plate bottom (215), proximal the at least one first yaw assembly plate extension edge (213), and at least one second aperture (227) from the second yaw assembly plate top (224) to the second yaw assembly plate bottom (225), proximal the second extension edge (223) wherein said at least one first aperture (217) and said at least one second aperture (227) are aligned to receive rotatable shaft or shaft interrelated with gear interconnecting means. Said shaft or shaft interrelated with gear interconnecting means receives yaw power means to urge the rotation of the at least one first yaw assembly plate (210) relative to the at least one second yaw assembly plate (220).

Rotatable yaw power means is comprised of a motor means (400) driving a motor shaft (410). The motor means (400) is stationarily fixed by stationary fixing means at either the first yaw assembly plate top (214), the first yaw assembly plate bottom (215), the second yaw assembly plate top (224) or the second yaw assembly plate bottom (225); where the motor means (400) is affixed. Stationary fixing means includes bolt/nut, welding, riveting and such other equivalent means. In the preferred embodiment the motor means is affixed by motor mounting means to the at least one second yaw assembly plate (220) such that the motor shaft (410), either directly or by gear means torque connected to the shaft or shaft interrelated with gear interconnection means, key notch means or gear means is interconnected to the at least one first yaw assembly plate (210) thereby causing yaw power to be exerted to cause the at least one second yaw assembly plate (220) to yaw rotate relative to the at least one first yaw assembly plate (210). Stationary fixing means and motor mount means includes bolt/nut, welding, riveting and such other equivalent means.

The motor means (400) yaw power to the shaft (410) is key (420)and notch (425) interrelated or the shaft (410) is interrelated with gear means (430) interconnection at the at least one first aperture (217) or at the at least one second aperture (227) to urges the respective at least one first yaw assembly plate (210) to yaw rotate relative to the at least one second yaw assembly plate (220) responsive to power means signals received by the motor means (400) at signal input means (440). In the embodiments of this invention motor means (400), as will be appreciated by those of ordinary skills, are comprised of electric, pneumatic or hydraulic motors with operating signals or forces transmitted by steering means. Those of ordinary skills in motor arts will appreciate that electric signals or pneumatic or hydraulic forces are transmitted by known structures from the turning or operations of a steering means.

Roll Assembly

A roll assembly (300) has roll means. The roll assembly (300) has yaw-roll assembly interconnection means of the yaw assembly (200) and the roll assembly (300) and has roll interconnection means to the second vehicle unit(20). The roll means allows a roll relationship between the first vehicle unit (10) and the second vehicle unit (20). The roll assembly (300) has a yaw-roll interface plate (310); the yaw-roll interface plate (310) is fixedly connected, by plate affixing means, to at least one second yaw assembly plate (220). The yaw-roll assembly interconnection means yaw rotatably interconnects the yaw assembly (200) with the roll assembly (300). The yaw-roll interface plate (310) is interconnected by roll means with a second roll interconnection plate (320). The second roll interconnection plate (320) is affixed by immovable plate affixing means to the second vehicle unit (20). Roll means is comprised of first roll interconnecting means (330) received by second roll interconnecting means (340). In the embodiments of this invention, the first roll interconnecting means (330) is comprised of threaded means received by second roll interconnecting means (340) which are comprised of complementary receiving threaded means, i.e., as will be appreciated by those of ordinary skills, where the first roll interconnecting means (330) is a male threaded element, the second roll interconnecting means (340) will be a female threaded element.

The first roll interconnecting means (330), in the embodiments of this invention, is comprised of threaded means received by second roll interconnecting means (340) comprised of complementary receiving threaded means. The first roll interconnecting means (330) is immovably affixed to second roll interconnection plate (320) at a roll side (321). Immovable affixing means includes welding, nut and bolt, riveting and such. The second roll interconnection plate (320) is affixed by means to the second vehicle (20) at a roll-vehicle side (322).

The first pitch interconnection plate (110), the pitch assembly attachment plate (120), the at least one first yaw assembly plate(210), the at least one second yaw assembly plate (220), the yaw-roll interface plate (310), and the second roll interconnection plate (320) are substantially planar and will generally be constructed of a rigid material with strength sufficient to withstand yaw, pitch and roll stresses imposed as a multi-unit vehicle is in transit. The material will generally be metal including but not limited to steel plate.

An Alternative Embodiment

In an alternative embodiment the at least one first yaw assembly plate (210) comprised of at least at least one first yaw assembly plate(210) and at least one first top assembly plate (211). The at least one first yaw assembly plate (210) has a first yaw assembly plate edge (212), an extension edge (213), a first yaw assembly plate top (214) and a first yaw assembly plate bottom (215); the at least one first yaw assembly plate edge (212) immovably affixed by edge affixing means at the assembly plate second side (123). The extension edge (213) is distal from the first yaw assembly plate edge (212). The at least first yaw assembly plate (210) extends from the assembly plate second side (123) outwardly from the assembly plate second side (123).

The at least one top yaw assembly plate (211) has a first yaw assembly plate edge (232), an extension edge (233), a top yaw assembly plate top (234) and a top yaw assembly plate bottom (235); the at least one top yaw assembly plate edge (232) immovably affixed by edge affixing means at the assembly plate second side (123). The extension edge (233) is distal from the top yaw assembly plate edge (232). The at least one top yaw assembly plate (211) extends from the assembly plate second side (123) outwardly from the assembly plate second side (123).

The pitch assembly attachment plate (120) is immovably connected, by immovable affixing means, to the at least one first yaw assembly plate (210) proximal the assembly plate bottom (127) and the at least one first top assembly plate (211) proximal the assembly plate top (126).

The at least one second yaw assembly plate (220) is comprised of at least at least one second yaw assembly plate (220) and at least one second top assembly plate (221). The at least one second yaw assembly plate (220) has a second yaw assembly plate edge (222), an extension edge (223), a second yaw assembly plate top (224) and a second yaw assembly plate bottom (225). The at least one second yaw assembly plate edge (222) is immovably affixed by edge affixing means at the yaw-roll interface plate (310) at the yaw surface (314). The extension edge (223) is distal from the second yaw assembly plate edge (222). The at least second yaw assembly plate (211) extends from the yaw-roll interface plate (310) outwardly from the yaw-roll interface plate (310).

The at least one second top assembly plate (221) has a second top yaw assembly plate edge (242), an extension edge (243), a second yaw top assembly plate top (244) and a second yaw top assembly plate bottom (245). The at least one second yaw top assembly plate edge (242) is immovably affixed by edge affixing means at the yaw-roll interface plate (310) at the yaw surface (314). The extension edge (243) is distal from the second top assembly plate edge (242) and the at least second top yaw assembly plate (221) extends from the yaw-roll interface plate (310) outwardly from the yaw-roll interface plate (310).

The at least one second yaw assembly plate (220) is immovably affixed by immovable affixing means, at the yaw-roll interface plate (310) at the yaw surface (314) proximal the yaw-roll inter face plate bottom (312) and the at least one second top assembly plate (221) is immovably affixed by immovable affixing means at the yaw-roll interface plate (310) at the yaw surface (314) proximal the yaw-roll interface plate top (311).

Yaw interconnection means interconnecting the at least one first yaw assembly plate (210) and the at least one second yaw assembly plate (220) by aligned apertures, proximal the extension edges (213) and (233), receiving shaft interconnection means (500) or yaw power by motor means (400) and motor shaft means (410) or motor shaft means (410) with gear means (430). Yaw interconnection means interconnects the at least one top yaw assembly plate (211) and the at least one second top yaw assembly plate (221) by aligned apertures, proximal the extension edges (233) and (243), receiving shaft interconnection means (500) or yaw power by motor means (400) and motor shaft means (410) or motor shaft means (410) with gear means (430). Rotatable yaw power means comprised of a motor (400) driving a motor shaft (410); the motor (400) stationarily fixed by stationary fixing means at either the first yaw assembly plate top (214), the first yaw assembly plate bottom (215), the second yaw assembly plate top (224) or the second yaw assembly plate bottom (225); the motor shaft (410) either directly or by gear means (430) torque connected to the shaft (410) or shaft interrelated with gear interconnection.

In the embodiments of this invention shaft interconnection means (500) may be comprised, but is not limited to, nut and bolt (500) connection means. Yaw power by motor means (400) is comprised of electric, pneumatic or hydraulic motor means with shaft (410), key (420) and notch (425) or shaft (410) and gear (430) drive means. The first pitch interconnection plate (110), the pitch assembly attachment plate (120), the at least one first yaw assembly plate(210), the at least one top yaw assembly plate (211), the at least one second yaw assembly plate (220), the at least one top second yaw assembly plate (221) the yaw-roll interface plate (310), and the second roll interconnection plate (320) are substantially planar.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. A yaw, pitch and roll articulated assembly (1) for a multi-unit vehicle comprised of:
a. a pitch assembly (100) with pitch means (130); said pitch assembly (100) having pitch assembly interconnection means to a first vehicle unit (10); pitch means (130) allowing a pitch relationship between the first vehicle unit (10) and a second vehicle unit (20);
b. a yaw assembly (200) with yaw means; said yaw assembly (200) having pitch-yaw assembly interconnection means of the pitch assembly (100) and the yaw assembly (200); the yaw assembly (200) having yaw-roll assembly interconnection means; yaw means allowing a yaw relationship between the first vehicle unit (10) and the second vehicle unit (20);
c. a roll assembly (300) with roll means; said roll assembly (300) having yaw-roll assembly interconnection means of the yaw assembly (200) and the roll assembly (300) and having roll interconnection means to the second vehicle unit(20); roll means allowing a roll relationship between the first vehicle unit (10) and the second vehicle unit (20).

2. A yaw, pitch and roll articulated assembly of claim 1 further comprising:
a. the pitch assembly interconnection means to a first vehicle unit (10) comprised of a first pitch interconnection plate (110) affixed by interconnection affixing means to the first vehicle unit (10);
b. the first pitch interconnection plate (110) is pitch rotatably affixed by pitch interconnection affixing means (130) to a pitch assembly attachment plate (120);
c. the pitch assembly attachment plate (120) is immovably connected, by affixing means, to at least one first yaw assembly plate(210);
d. the pitch-yaw assembly interconnection means of the pitch assembly (100) and the yaw assembly (200) rotatably interconnecting the pitch assembly (100) with the yaw assembly (200);
e. the roll assembly (300) having a yaw-roil interface plate (310); the yaw-roll interface plate (310) fixedly connected, by plate affixing means, to at least one second yaw assembly plate (220); the yaw-roll assembly interconnection means yaw rotatably interconnecting the yaw assembly (200) with the roll assembly (300); the yaw-roll interface plate (310) interconnected by roll means with a second roll interconnection plate (320); the second roll interconnection plate (320) affixed by plate affixing means to the second vehicle unit (20).

3. A yaw, pitch and roll articulated assembly of claim 2 further comprising:
a. the pitch assembly attachment plate (120) having an assembly plate first side (122), an assembly plate second side (123), an assembly plate top (126) and an assembly plate bottom (127);
b. the first pitch interconnection plate (110) affixed by rotatable pitch interconnection affixing means (130) to the pitch assembly attachment plate (120) at the assembly plate front side (124) proximal the assembly plate bottom (127) or at the assembly plate bottom (127);
c. the at least one first yaw assembly plate (210) having a first yaw assembly plate edge (212), an extension edge (213), a first yaw assembly plate top (214) and a first yaw assembly plate bottom (215); the at least one first yaw assembly plate edge (212) immovably affixed by edge affixing means at the assembly plate second side (123); the extension edge (213) distal from the first yaw assembly plate edge (212); the at least first yaw assembly plate (210) extending from the assembly plate second side (123) outwardly from the assembly plate second side (123);
d. the at least one second yaw assembly plate (220) having a second yaw assembly plate edge (222), a second extension edge (223), a second yaw assembly plate top (224) and a second yaw assembly plate bottom (225); the at least one second yaw assembly plate edge immovably affixed by edge affixing means at the yaw-roll interface plate (310) at a yaw surface (314); the second extension edge (223) distal from the at least second yaw assembly plate edge (222); the at least second yaw assembly plate (220) extending from the yaw surface (314) outwardly from the yaw surface (314); the yaw-roll interface plate (310) having a yaw-roll interface plate top (311) and a yaw-roll interface plate bottom (312);
e. yaw interconnection means interconnecting the at least one first yaw assembly plate (210) and the at least one second yaw assembly plate (220) proximal the respective extension edge and second extension edge; yaw interconnection means receiving yaw power means to urge the at least one first yaw assembly plate (210) to yaw rotate with respect to the at least one second assembly plate (220).

4. A yaw, pitch and roll articulated assembly of claim 3 further comprising:
a. the first yaw assembly plate edge (212) immovably affixed by edge affixing means at the assembly plate second side (123) intermediate the assembly plate top (126) and the assembly plate bottom (127) or proximal the assembly plate bottom (127); yaw interconnection means interconnecting the at least one first yaw assembly plate (210) and the at least one second yaw assembly plate (220) proximal the respective extension edge (213) and second extension edge (223) comprised of at least one first aperture (217), from the first yaw assembly plate top (214) to the first yaw assembly plate bottom (215), proximal the at least one first yaw assembly plate extension edge (213), and at least one second aperture (227) from the second yaw assembly plate top (224) to the second yaw assembly plate bottom (225), proximal the second extension edge (223) wherein said at least one first aperture (217) and said at least one second aperture (227) are aligned to receive rotatable shaft or shaft interrelated with gear interconnecting means; said shaft or shaft interrelated with gear interconnecting means receiving yaw power means to urge the rotation of the at least one first yaw assembly plate (210) relative to the at least one second yaw assembly plate (220);
b. the first pitch interconnection plate (110) affixed by rotatable pitch interconnection affixing means (130) to the assembly plate first side (122) intermediate the assembly plate top (126) and the assembly plate bottom (127) or proximal the assembly plate bottom (127);
c. the first pitch interconnection plate (110), the pitch assembly attachment plate (120), the at least one first yaw assembly plate(210), the at least one second yaw assembly plate (220), the yaw-roll interface plate (310), and the second roll interconnection plate (320) are substantially planar;
d. rotatable pitch interconnection affixing means (130) comprised of hinge means (130); roll means comprised of first roll interconnecting means (330) received by second roll interconnecting means (340).

5. A yaw, pitch and roll articulated assembly of claim 4 further comprising:
a. rotatable yaw power means comprised of a motor means (400) driving a motor shaft (410); the motor means (400) stationarily fixed by stationary fixing means at either the first yaw assembly plate top (214), the first yaw assembly plate bottom (215), the second yaw assembly plate top (224) or the second yaw assembly plate bottom (225); where the motor means (400) is affixed to the at least one first yaw assembly plate (210) the motor shaft (410), either directly or by gear means torque connected to the shaft or shaft interrelated with gear interconnection means, key notch or gear interconnected to the at least one second yaw assembly plate (220); where the motor means (400) is affixed to the at least one second yaw assembly plate (220) the motor shaft (410), either directly or by gear means torque connected to the shaft or shaft interrelated with gear interconnection means, key notch means or gear means interconnected to the at least one first yaw assembly plate (210);
b. first roll interconnecting means (330) comprised of threaded means received by second roll interconnecting means (340) comprised of complementary receiving threaded means.

6. A yaw, pitch and roll articulated assembly of claim 5 further comprising:
a. motor means (400) yaw power to the shaft (410), key (420) and notch (425) or to shaft (410) interrelated with gear means (430) interconnection at the at least one first aperture (217) or at the at least one second aperture (227) urges the respective at least one first yaw assembly plate (210) to yaw rotate relative to the at least one second yaw assembly plate (220) responsive to power means signals received by the motor means (400) at signal input means ((440); motor means comprised of electric, pneumatic or hydraulic power transmitted by steering means;
b. first roll interconnecting means (330) comprised of threaded means received by second roll interconnecting means (340) comprised of complementary receiving threaded means; first roll interconnecting means (330) immovably affixed to second roll interconnection plate (320) at a roll side (321); the second roll interconnection plate (320) affixed by means to the second vehicle (20) at a roll-vehicle side (322)

7. A yaw, pitch and roll articulated assembly of claim 3 further comprising:
a. the at least one first yaw assembly plate (210) comprised of at least at least one first yaw assembly plate (210) and at least one first top assembly plate (211);
b. the at least one first yaw assembly plate (210) having a first yaw assembly plate edge (212), an extension edge (213), a first yaw assembly plate top (214) and a first yaw assembly plate bottom (215); the at least one first yaw assembly plate edge (212) immovably affixed by edge affixing means at the assembly plate second side (123); the extension edge (213) distal from the first yaw assembly plate edge (212); the at least first yaw assembly plate (210) extending from the assembly plate second side (123) outwardly from the assembly plate second side (123);
c. the at least one top yaw assembly plate (211) having a first yaw assembly plate edge (232), an extension edge (233), a top yaw assembly plate top (234) and a top yaw assembly plate bottom (235); the at least one top yaw assembly plate edge (232) immovably affixed by edge affixing means at the assembly plate second side (123); the extension edge (233) distal from the top yaw assembly plate edge (232); the at least one top yaw assembly plate (211) extending from the assembly plate second side (123) outwardly from the assembly plate second side (123);
d. the pitch assembly attachment plate (120) is immovably connected, by immovable affixing means, to the at least one first yaw assembly plate (210) proximal the assembly plate bottom (127) and the at least one first top assembly plate (211) proximal the assembly plate top (126);
e. the at least one second yaw assembly plate (220) comprised of at least at least one second yaw assembly plate(220) and at least one second top assembly plate (221);
f. the at least one second yaw assembly plate (220) having a second yaw assembly plate edge (222), an extension edge (223), a second yaw assembly plate top (224) and a second yaw assembly plate bottom (225); the at least one second yaw assembly plate edge (222) immovably affixed by edge affixing means at the yaw-roll interface plate (310) at the yaw surface (314); the extension edge (223) distal from the second yaw assembly plate edge (222); the at least second yaw assembly plate (211) extending from the yaw-roll interface plate (310) outwardly from the yaw-roll interface plate (310);
g. the at least one second top assembly plate (221) having a second top yaw assembly plate edge (242), an extension edge (243), a second yaw top assembly plate top (244) and a second yaw top assembly plate bottom (245); the at least one second yaw top assembly plate edge (242) immovably affixed by edge affixing means at the yaw-roll interface plate (310) at the yaw surface (314); the extension edge (243) distal from the second top assembly plate edge (242); the at least second top yaw assembly plate (221) extending from the yaw-roll interface plate (310) outwardly from the yaw-roll interface plate (310);
h. the at least one second yaw assembly plate (220) is immovably affixed by immovable affixing means, at the yaw-roll interface plate (310) at the yaw surface (314) proximal the yaw-roll inter face plate bottom (312) and the at least one second top assembly plate (221) is immovably affixed by immovable affixing means at the yaw-roll interface plate (310) at the yaw surface (314) proximal the yaw-roll interface plate top (311);
i. yaw interconnection means interconnecting the at least one first yaw assembly plate (210) and the at least one second yaw assembly plate (220) by aligned apertures, proximal the extension edges (213) and (233), receiving shaft interconnection means (500) or yaw power by motor means (400) and motor shaft means (410217) or motor shaft means (410) with gear means (430);
j. yaw interconnection means interconnecting the at least one top yaw assembly plate (211) and the at least one second top yaw assembly plate (221) by aligned apertures proximal the extension edges (233) and (243), receiving shaft interconnection means (500) or yaw power by motor means (400) and motor shaft means (410) or motor shaft means (410) with gear means (430).

8. A yaw, pitch and roll articulated assembly of claim 7 further comprising:
a shaft interconnection means (500) comprised of nut and bolt (500) connection means; yaw power by motor means (400) comprised of electric, pneumatic or hydraulic motor means with drive means;
b. the first pitch interconnection plate (110), the pitch assembly attachment plate (120), the at least one first yaw assembly plate(210), the at least one top yaw assembly plate (211), the at least one second yaw assembly plate (220), the at least one top second yaw assembly plate (221) the yaw-roll interface plate (310), and the second roll interconnection plate (320) are substantially planar;
c. rotatable pitch interconnection affixing means (130) comprised of binge means (130); roll means comprised of first roll interconnecting means (330) received by second roll interconnecting means (340).

9. A yaw, pitch and roll articulated assembly of claim 8 further comprising:
a. rotatable yaw power means comprised of a motor driving a motor shaft; the motor stationarily fixed by stationary fixing means at either the first yaw assembly plate top, the first yaw assembly plate bottom, the second yaw assembly plate top or the second yaw assembly plate bottom; drive means comprised of shaft (410), key (420) and notch (425) or shaft (410) and gear (430) drive means; the motor shaft either directly or by gear means torque connected to the shaft or shaft interrelated with gear interconnection;
b. first roll interconnecting means (330) comprised of threaded mews received by second roll interconnecting means (340) comprised of complementary receiving threaded means; first roll interconnecting means (330) immovably affixed to second roll interconnection plate (320) at a roll side (321); the second roll interconnection plate (320) affixed by means to the second vehicle (20) at a roll-vehicle side (322).

10. A yaw, pitch and roll articulated assembly of claim 9 further comprising:
a. shaft or shaft interrelated with gear interconnection is key means interrelated at the at least one first aperture or at the at least one second aperture by shaft or aperture key received by shaft or aperture notch; means of transmitting yaw power to the motor.
